(19) United States
(12) Patent Application Publication
(10) Pub. No.: US 2008/0035088 A1
(43) Pub. Date: Feb. 14, 2008

(54) Laser ignition arrangement

(76) Inventors: Johann Klausner, St. Jakob (AT); Heinrich Kofler, Vienna (AT); Martin Weinrotter, Vocklabruck (AT); Josef Graf, Grosspetersdorf (AT)

Correspondence Address: WENDEROTH, LIND & PONACK, L.L.P., 2033 K STREET N. W., SUITE 800, WASHINGTON, DC, 20006-1021, US

(21) Appl. No.: 11/889,155

(22) Filed: Aug. 9, 2007

(30) Foreign Application Priority Data
Aug. 9, 2006 (AT) A 1334/2006

(51) Int. Cl. F02P 23/04

(52) U.S. Cl. 123/143 B

(57) ABSTRACT

A laser ignition arrangement for an internal combustion engine (1) comprising a laser light generating device (3) and a combustion chamber window (7, 7′) through which laser light (5) for ignition of a combustible mixture can be introduced into a combustion chamber (11) of the internal combustion engine (1), wherein the laser light generating device (3) is suitable for introducing laser light of an intensity (I) of at most 0.15 mJ/mm² or at least 3 mJ/mm² into the combustion chamber (11), wherein the intensity (I) can be attained on a side of the clean combustion chamber window (7, 7′), which side is towards the combustion chamber (11).

The present invention concerns a laser ignition arrangement for an internal combustion engine comprising a laser light generating device and a combustion chamber window through which laser light for ignition of a combustible mixture can be introduced into a combustion chamber of the internal combustion engine. In addition the invention concerns an internal combustion engine having a corresponding laser ignition arrangement.

A serious obstacle to the large-scale use of laser ignition arrangements of the general kind set forth for internal combustion engines consists of unwanted interactions between the laser light and the combustion chamber window. Those impairments in light transmissivity occur upon passing into the combustion chamber window, in transmission and upon issuing from the combustion chamber window, at the combustion chamber side.

An object of the invention is to develop a laser-ignition internal combustion engine of the general kind set forth in such a way that unwanted laser-induced changes in the combustion chamber window are minimised.

In accordance with the invention that is achieved in that the laser light generating device is suitable for introducing laser light of an intensity of at most 0.15 mJ/mm² (millijoule per square millimetre) or at least 3 mJ/mm² into the combustion chamber, wherein the intensity can be attained on a side of the clean combustion chamber window, which side is towards the combustion chamber.

It has been found that laser-induced changes in the combustion chamber window can be divided essentially into three ranges which differ by virtue of differing levels of radiation intensity. In a first range involving an intensity of less than or equal to 0.15 mJ/mm², no laser-induced coating effect occurs at the combustion chamber window. In a second range of medium intensity, that is to say in the range of greater than 0.15 mJ/mm² and less than 3 mJ/mm², the laser light becomes coating-promoting by virtue of photochemical processes, whereby light transmissivity is worsened. In the third range involving levels of intensity of 3 mJ/mm² and more, a coating which is possibly present or which is promoted by the laser light is removed again by the laser light. Overall therefore it is surprisingly found that, to avoid laser-induced coating of the combustion chamber window, it is either possible to operate in the above-mentioned first range in which such laser-induced deposits and fouling do not occur at all or in the third range in which the fouling which is possibly present on the combustion chamber window is burnt away by the laser energy. In the second range between 0.15 and 3 mJ/mm² deposits of carbon are formed in the region where the beam passes therethrough, which deposits absorb the laser energy and result in failure of the ignition system.

The applicants' tests have revealed that the levels of intensity available are also sufficient in the first range of less than 0.15 mJ/mm² to generate a laser-induced plasma which is necessary for laser ignition, in the fuel-air mixture. It will be appreciated that laser generation is also ensured at levels of intensity of greater than 3 mJ/mm².

A combustion chamber window is assumed to be a clean combustion chamber window in accordance with claim 1 if at least 70% of the laser energy impinging on the side of the combustion chamber window, that is remote from the combustion chamber, issues again on the combustion chamber side of the combustion chamber window, that is to say is transmitted through the combustion chamber window and its surfaces.

Further features and details of the present invention will be apparent from the description hereinafter of the embodiments by way of example of the invention, which are shown in the Figures in which:

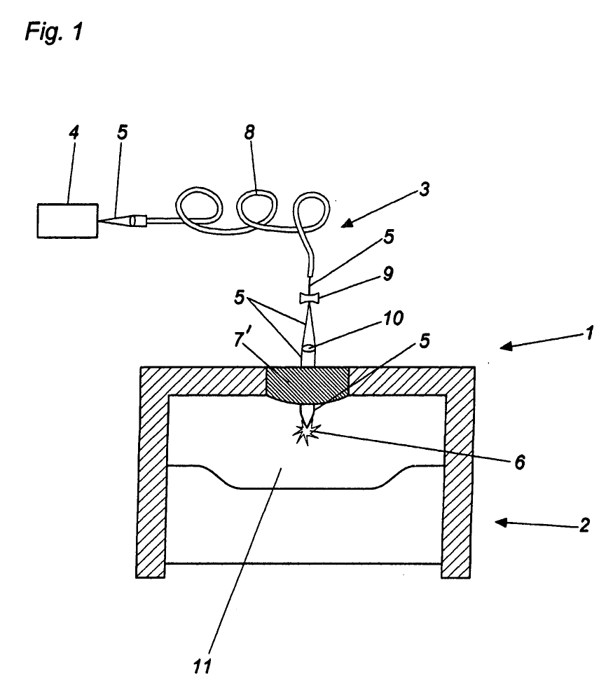

FIG. 1 is a diagrammatically illustrated cylinder of an internal combustion engine with a laser ignition arrangement in accordance with the invention,

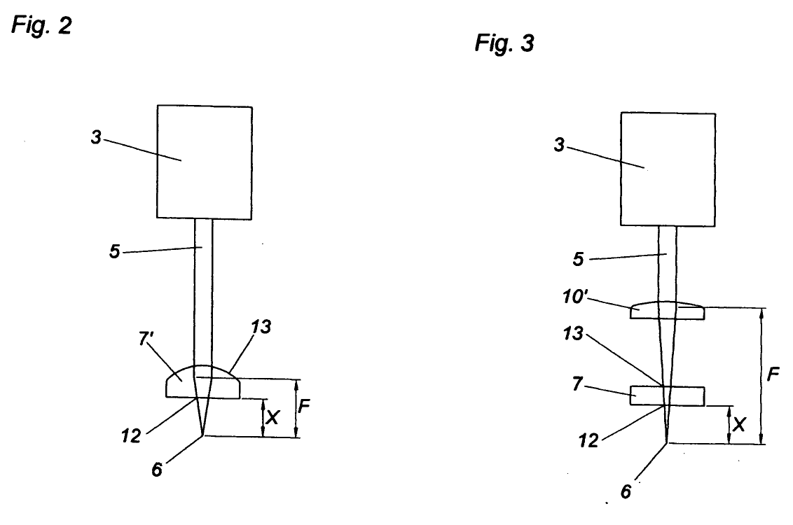

FIG. 2 shows a second embodiment according to the invention of a laser ignition arrangement with a combustion chamber window which is shaped lens-like,

FIG. 3 shows a third variant according to the invention in which the focusing optical means and the combustion chamber window are in the form of separate components, and

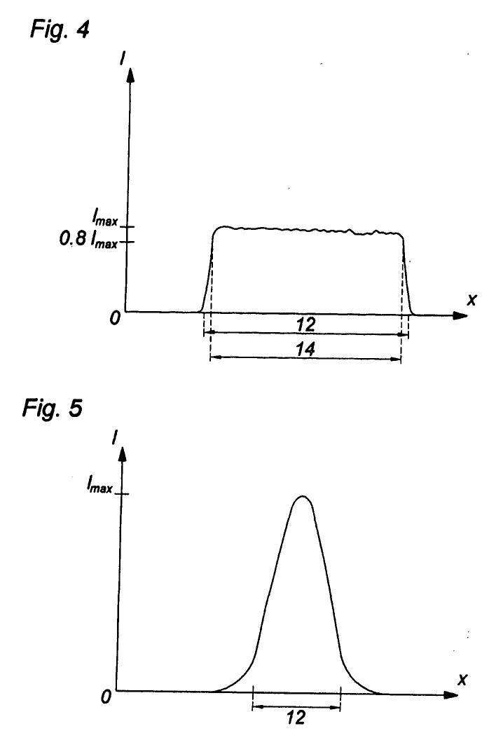

FIGS. 4 and 5 are diagrammatic representations relating to various spatial intensity distributions of the laser light beam.

FIG. 1 shows a cylinder 2 of an internal combustion engine 1 which generally has a plurality of cylinders. Laser light is introduced into the combustion chamber 11 by means of the laser light generating device 3 and focused on the focus volume 6. In this embodiment of the invention the laser light generating device 3 includes a laser resonator 4, an optical waveguide 8 and an optical expansion means formed by the lenses 9 and 10. At the combustion chamber side the combustion chamber window 7′ is in the form of a convergent lens for focusing the laser light 5. In this variant the focusing optical means is therefore integrated into the combustion chamber window 7′.

This embodiment therefore provides that the laser resonator 4 is not arranged directly at the combustion chamber window. That has the advantage that the magnitude of the mechanical and thermal stresses is kept low. The transmission device for transmitting the laser light 5 to the combustion chamber window 7 in this embodiment includes both the optical waveguide 8 and also the lenses 9 and 10. It is however also possible to use any other transmission devices which are suitable for laser light and which are known in the state of the art. It will be appreciated that it is alternatively also possible for the laser light generating device 3 formed by the laser resonator 4 and the specified optical components to be arranged directly at the combustion chamber window 7′, that thereby affording a laser ignition arrangement which is overall highly integrated.

In a particularly preferred feature it is provided that the laser light generating device 3 introduces pulsed laser light 5 into the combustion chamber 11. In that case the pulse durations are desirably between 0.1 ns and 20 ns, preferably between 0.5 ns and 10 ns. In the case of pulsed laser light the levels of intensity specified in accordance with the invention are then desirably levels of energy intensity which are averaged in respect of time over the pulse duration. In that case the pulse duration can be defined as the period of time of a pulse, which is between the 50% values of the rising and falling pulse edges, with respect to the maximum amplitude. That definition is generally referred to as the full width at half maximum definition.

The laser light generating device 3 used can be for example Nd: YAG lasers which are known in the state of the art and which are pumped by means of flash lamps and which involve active Q-switching, with pulse durations of between 5 and 10 ns and laser energies of between 0 and 200 mJ, or diode-pumped passively Q-switched Nd: YAG lasers with pulse durations of between 0.5 and 5 ns and laser energies of between 0 and 20 mJ.

In the embodiments of laser ignition arrangements according to the invention as shown in FIGS. 2 and 3 the laser light generating device 3 is in each case shown in greatly simplified fashion in the form of a rectangle. It can be designed for example as shown in FIG. 1. In FIG. 2 the focusing optical means is integrated into the combustion chamber window 7′ as in the embodiment of FIG. 1, but arranged on the side that is remote from the combustion chamber 11.

FIG. 3 shows an embodiment in which the combustion chamber window 7 and the focusing lens or optical means 10 are in the form of separate components. Here the focusing optical means 10′ is disposed in front of the combustion chamber window on its side remote from the combustion chamber 11. In both embodiments F denotes the focal length of the focusing optical means, that is to say in the embodiment of FIG. 2 the focal length of the self-focusing combustion chamber window 7′ and in FIG. 3 the focal length of the focusing lens 10′. X denotes the spacing of the beam exit surface 12 at the combustion chamber side, from the focal point or focus volume 6 in the beam direction. The laser light 5 passes into the combustion chamber window 7 or 7′ respectively on the side remote from the combustion chamber 11, with the beam entry surface 13 and a beam entry diameter D₀ to be associated therewith, and a laser energy E₀. It leaves the combustion chamber window in the region of the beam exit surface 12 with a beam exit diameter D₁ and a laser energy E₁. As already discussed in the opening part of this specification, it is to be assumed that a combustion chamber window 7 or 7′ respectively is sufficiently clean, if the following applies:

$$\frac{{E}_{1}}{{E}_{0}} \geq 0.7$$

The following applies for the beam exit diameter:

D₁=D₀·X/F

As was found in accordance with the invention a decisive parameter in regard to keeping the combustion chamber window 7 or 7′ clean is the intensity or energy intensity I. That results from the quotient of laser energy E₁ and the beam exit surface 12 at the surface of the combustion chamber window 7 or 7′ respectively, which is at the combustion chamber side:

I=4·E₁/(D₁²·π)=4·E₁·F²/(D₀²·X²·π).

Desirably the intensities I according to the invention are energy intensities which are averaged not only in respect of time but also in respect of space. In that respect, the expression intensity I which is averaged in respect of space is used to mean the intensity which is averaged over the beam exit surface 12 of the laser light beam 5. Calculation of the beam exit surface 12 is effected by way of the beam exit diameter D₁. The beam exit diameter D₁ can be calculated like any beam diameter from the optical data and the geometrical arrangement. Alternatively it is possible to use a beam profiler to measure the beam diameter or the effective beam area along the beam propagation direction in order in that way to extrapolate the beam exit diameter D₁ or the beam exit surface 12 at the combustion chamber window 7 or 7′ respectively. In that respect reference is generally to be made to the definition of the Gaussian beam, for the definition of the beam diameter—as specifically also for the beam exit diameter D₁. The beam diameter is defined as that value at which the power density [W/m²] falls to 1/e² (≈13.5%) of the maximum value. The step of determining the energies E₀ and E₁ is effected by way of a commercially available pulse energy measuring device, for example a pyroelectric detector. Alternatively it is also possible to determine the energy intensity I which is averaged in respect of time, at the combustion chamber window 7 or 7′ respectively. For that purpose it is possible by means of a beam profiler to determine a beam profile which standardised with the pulse energy gives the absolute energy intensity profile.

The intensities I according to the invention can be achieved with various spatial intensity distributions. It is desirable if the intensity distribution is substantially constant over the beam diameter D₁. That is generally assumed to be the case if—as shown in FIG. 4 by means of an example—the intensity I in a core region 14 of the beam exit surface 12 falls at most by 20%, preferably at most by 10%, with respect to the intensity value Iₘₐₓ which occurs at a maximum in the beam exit surface 12, in which respect the area of the core region 14 is at least 80% and preferably at least 90% of the beam exit surface 12. FIG. 4 is a graphic representation showing a radial section through the intensity distribution in the beam exit surface 12. In the ideal situation such an intensity distribution is substantially in the form of a rectangle. In this respect the height of the rectangle is so selected that it is either less than or equal to 0.15 mJ/mm² or is at least 3 mJ/mm². The spatial extent or width of the rectangle is essentially given by the beam diameter D₁ or the core region 12 thereof. Such a profile represents the intensity distribution with maximum energy input without local intensities having to be feared in the value range to be avoided of between 0.15 mJ/mm² and 3 mJ/mm².

Although a substantially rectangular intensity distribution as shown in FIG. 4 is preferred the invention is not restricted to such intensity distributions. It would also be possible to conceive for example a Gaussian intensity distribution profile (TEM₀₀ profile), as is shown in FIG. 5. Such a profile has the advantage of most easily leading to a laser-induced breakthrough. On the other hand the rectangular profile shown in FIG. 4 has the advantage of permitting maximum overall energy with minimum intensity peak.

The concept according to the invention is suitable for the ignition of all fuel-air mixtures but in particular for methane-air mixtures in an air-fuel ratio λ of between about 1.5 and 2.5, preferably between 1.8 and 2.2.

1. A laser ignition arrangement for an internal combustion engine comprising a laser light generating device and a combustion chamber window through which laser light for ignition of a combustible mixture can be introduced into a combustion chamber of the internal combustion engine, wherein the laser light generating device is suitable for introducing laser light of an intensity of at most 0.15 mJ/mm² or at least 3 mJ/mm² into the combustion chamber, wherein the intensity can be attained on a side of the clean combustion chamber window, which side is towards the combustion chamber.

2. A laser ignition arrangement as set forth in claim 1 wherein the laser light generating device is provided for introducing pulsed laser light into the combustion chamber.

3. A laser ignition arrangement as set forth in claim 1 wherein the laser light generating device is provided for introducing pulsed laser light of a pulse duration of between 0.1 ns and 20 ns into the combustion chamber.

4. A laser ignition arrangement as set forth in claim 3 wherein the laser light generating device is provided for introducing pulsed laser light of a pulse duration of between 0.5 ns and 10 ns into the combustion chamber.

5. A laser ignition arrangement as set forth in claim 2 wherein the intensity is an intensity which is time-averaged over the pulse duration.

6. A laser ignition arrangement as set forth in claim 1 wherein the intensity is an intensity which is averaged over a beam exit surface of the laser light on the side of the combustion chamber window that is towards the combustion chamber.

7. A laser ignition arrangement as set forth in claim 1 wherein the intensity in a core region of a beam exit surface arranged at the combustion chamber window at the combustion chamber side falls at most by 20% with respect to the intensity value occurring at a maximum in the beam exit surface, wherein the area of the core region is at least 80% of the beam exit surface.

8. A laser ignition arrangement as set forth in claim 7 wherein the intensity in said core region falls at most by 10% with respect to the intensity value occurring at a maximum in the beam exit surface.

9. A laser ignition arrangement as set forth in claim 7 wherein the area of said core region is at least 90% of the beam exit surface.

10. A laser ignition arrangement as set forth in claim 1 wherein the combustion chamber window has a focusing optical means on its side in opposite relationship to the combustion chamber or a focusing optical means is integrated into the combustion chamber window.

11. A laser ignition arrangement as set forth in claim 2 wherein an overall energy of a laser light pulse is so great that a methane-air mixture with an air-fuel ratio of between about 1.6 and 2.5 is ignitable.

12. A laser ignition arrangement as set forth in claim 11 wherein said overall energy of a laser light pulse is so great that a methane-air mixture with an air-fuel ration of between about 1.8 and 2.2 is ignitable.

13. A laser ignition arrangement as set forth in claim 1 wherein the laser light generating device includes a transmission device for transmission of the laser light to the combustion chamber window.

14. A laser ignition arrangement as set forth in claim 13 wherein said transmission device comprises at least one optical waveguide, at least one lens, or combinations thereof.

15. An internal combustion engine comprising a laser ignition arrangement as set forth in claim 1.
